(19) United States
(12) Patent Application Publication
(10) Pub. No.: US 2010/0269132 A1
(43) Pub. Date: Oct. 21, 2010

(54) Method and System For Inserting Advertisements In A Content Stream In Internet Protocol Television (IPTV)

(75) Inventor: George Foti, Dollard-des-Ormeaux (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 12/551,216

(22) Filed: Aug. 31, 2009

Related U.S. Application Data
(60) Provisional application No. 61/170,257, filed on Apr. 17, 2009.

(51) Int. Cl. H04N 7/025

(52) U.S. Cl. 725/32; 725/109; 725/88

(57) ABSTRACT

A method for inserting advertisements in a content stream in IPTV comprises: notifying an external decision point of advertisement insertion opportunities in the content stream; receiving, in response to the notification, advertisements selected by the external decision point, to be inserted in the advertisement insertion opportunities; and transmitting to a controlling node policies relative to the selected advertisements for insertion in the content stream. The method is carried out in a system, which comprises an advertisement management service for notifying the external decision point about the advertisement insertion opportunities, an input module, in response to the notification, for receiving the selected advertisements and an output module for transmitting to the controlling node the policies relative to the selected advertisements for insertion in the content stream.

### PRIORITY STATEMENT UNDER 35 U.S.C. S.119(e) & 37 C.F.R. S.1.78

This non-provisional patent application claims priority based upon the prior U.S. provisional patent application entitled “INTERWORKING BETWEEN IMS AND SCTE-BASED TARGETED ADVERTISEMENT SPECIFICATION”, application No. 61/170,257 filed Apr. 17, 2009, in the name of George Foti.

### TECHNICAL FIELD

The present invention generally relates to advertisements in IPTV networks. More specifically, the present invention is concerned with a method and system for inserting advertisements in a content stream in IPTV.

### BACKGROUND

Targeted advertisements form a very attractive feature when it comes to personalized IPTV. Indeed, the advertisements can be specially tailored and personalized to conform to the interests and tastes of each individual. In that way, targeted advertisements can be very efficient and thus can generate a lot of revenues. The Society of Cable Telecommunication Engineers (SCTE) has published a standard, entitled “SCTE 130-3 2009 Digital Program Insertion—Advertising Systems Interfaces Part 3—Ad Management Service (ADM) Interface”, which is publicly available at http://www.scte.org/documents/pdf/Standards/TopTen/SCTE_{—}130-3_{—}2009.pdf and which is incorporated herein by reference. The SCTE 130-3 standard has been adopted by several other standardization bodies and by service providers.

The main interaction specified by the SCTE is between two entities called ADvertisement Management service (ADM) and Advertisement Decision Service (ADS). Both also interact with background systems, comprising elements such as the Content Information Service (CIS), the Subscriber Information Service (SIS) and the Placement Opportunity Information Service (POIS) that are defined in other parts of the SCTE 130 standard.

The ADM tells the ADS, based upon triggers and other means, about opportunities for placing advertisements in a specific content stream, i.e. where the advertisements can be inserted. For example, the advertisements can be inserted at commercial breaks, at the beginning of a Voice on Demand (VoD) session, at the end of the VoD session, or after a “pause” command triggered by an end-user, etc. The role of the ADM is generally limited to the provision of opportunities and the role of the ADS is generally to decide which advertisements will be inserted in the specific content stream. The ADS returns its decision with the selected advertisements in a response to the ADM. The ADM completes the opportunity decision lifecycle by reporting activity events to the ADS.

Of course, there may exist other interactions between the ADM and the ADS, such as to update each other about opportunities and actual new advertisements chosen for insertion, about cancelled advertisements, etc.

After the ADS has accepted a placement suggestion from the ADM, the selected advertisements get inserted within the specific content stream that is being delivered to the end-user.

The SCTE standard mainly focuses on these two entities. Therefore, systems using the SCTE entities may be desirable.

### SUMMARY

More specifically, in accordance with the present invention, there is provided a method for inserting advertisements in a content stream in IPTV. The method comprises: notifying an external decision point of advertisement insertion opportunities in the content stream; receiving, in response to the notification, advertisements selected by the external decision point, to be inserted in the advertisement insertion opportunities; and transmitting to a controlling node policies relative to the selected advertisements for insertion in the content stream.

According to another aspect of the present invention, there is provided a system for inserting advertisements in a content stream in IPTV. The system comprises: an advertisement management service for notifying an external decision point of advertisements insertion opportunities in the content stream; an input module, in response to the notification, for receiving advertisements selected by the external decision point, to be inserted in the advertisement insertion opportunities; and an output module for transmitting to a controlling node policies relative to the selected advertisements for insertion in the content stream.

The foregoing and other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a schematic view of an interworking architecture between IPTV and an external network according to a non-restrictive illustrative embodiment of the present invention;

FIG. 2 is a flow chart illustrating a method of inserting advertisements in a content stream in IPTV according to a non-restrictive illustrative embodiment of the present invention;

FIG. 3 is a schematic view of a system for inserting advertisements in a content stream in IPTV according to a non-restrictive illustrative embodiment of the present invention;

FIGS. 4A to 4C are a call flow illustrating in more detail the method of inserting advertisements of FIG. 2 for a network approach of inserting the advertisements; and

FIGS. 5A to 5B are a call flow illustrating in more detail the method of inserting advertisements of FIG. 2 for a user terminal approach of inserting the advertisements.

### DETAILED DESCRIPTION

Before going further into the description, a glossary of acronyms is provided so as to better understand embodiments of the present invention and the acronyms used throughout the description.

Acronym Glossary

ADM ADvertisement Management service

ADS Advertisement Decision Service

ASM Authentication and Session Management

CC Cluster Controller

CDF Content Delivery Function

CDNC Content Delivery Network Controller

CIS Content Information Service

CS Content Server

HTTP HyperText Transfer Protocol

IG IMS Gateway

IMS Internet protocol Multimedia Subsystem

IPTV Internet Protocol Television

IPTV CS Internet Protocol Television Control Server

OITF Open IPTV Terminal Function

POIS Placement Opportunity Information Service

RAC Resource Admission Control

RTSP Real Time Streaming Protocol

SCTE Society of Cable Telecommunication Engineers

SDP Session Description Protocol

SIP Session Initiation Protocol

SIS Subscriber Information Service

UE User Equipment

VoD Video on Demand

XML eXtensible Markup Language

Generally stated, embodiments of the present invention allow for inserting advertisements in a content stream in IPTV, during a content on demand session, using an ADM and an ADS as defined in the SCTE 130 standard. Indeed, the ADM, located in an IPTV Control Server (IPTV CS) for example, notifies the ADS, located in an external network, about placement opportunities where advertisements can be inserted. Then, the ADS identifies and selects advertisements which are suitable for the placement opportunities received from the ADM, and sends the selected advertisements to the ADM. Upon receipt of the selected advertisements, the ADM defines policies associated with the selected advertisements for insertion in the content stream. The policies are then transmitted to a controlling node, which will perform the actual advertisement insertion according to the received policies. The content on demand session can be a multimedia or video on demand session.

As mentioned in the background section, the SCTE 130 standard defines the different interactions between the two entities, ADM and ADS, regarding placement opportunities of advertisements, as well as the selection of advertisements to be placed or inserted in a content stream. However, the SCTE 130 standard does not provide any mechanisms or suggestions for how to execute the actual placements of the selected advertisements, i.e. how policies related to the actual placements of the selected advertisements are defined and transmitted to the appropriate nodes, which would perform the actual insertion of the advertisements according to the defined policies. The embodiments of the present invention can overcome these shortcomings.

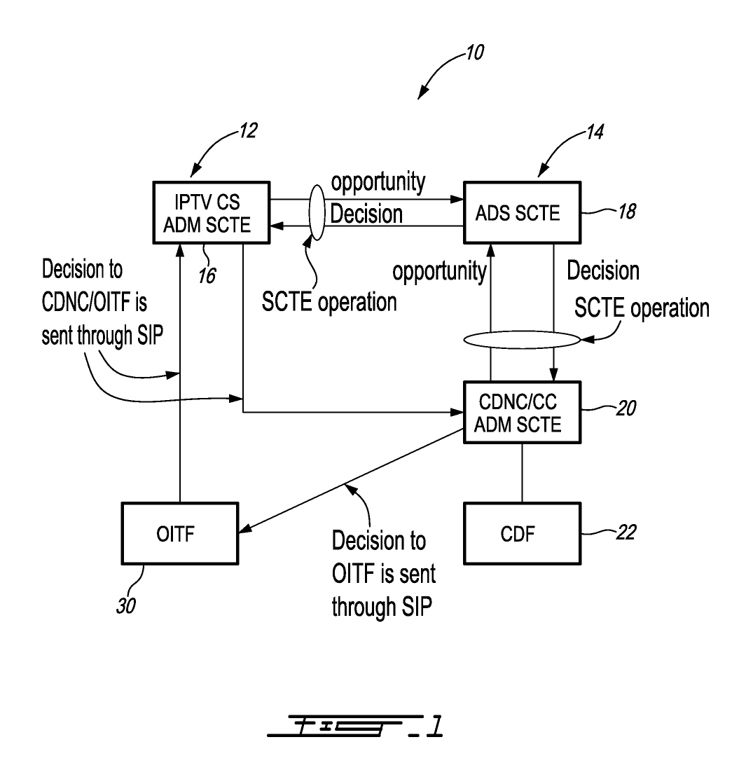

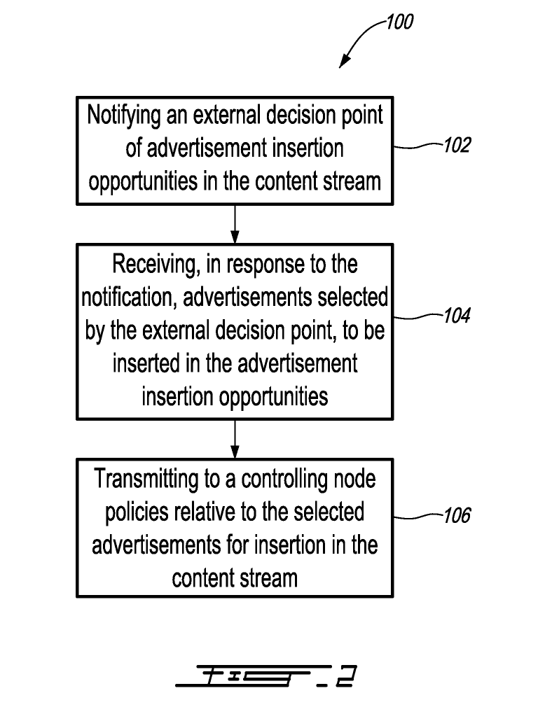

Now, turning to FIG. 1, a schematic view of an interworking architecture 10 between a system, such as an IP Multimedia Subsystem (IMS) system supporting IPTV, and an external network using the STCE standard will be described. Non-restrictive illustrative embodiments of the present invention will be described in the context of the infrastructure of the interworking architecture 10.

More specifically, the architecture 10 comprises an Internet Protocol Television Content Server (IPTV CS) 12, for providing IPTV services, and which is connected to an external network 14. The IPTV CS 12 includes an ADM 16 as defined by the SCTE 130 standard and the external network 14 includes an ADS 18 as defined by the SCTE 130 standard. The ADM 16 can be a logical entity, a piece of software, a piece of hardware, or a combination of both.

The IPTV CS 12 and the ADS 18 can be both connected to a controlling node. The controlling node can be a Content Delivery Network Controller (CDNC)/Cluster Controller (CC) 20, as defined by the Open IPTV forum, according to a first non-restrictive embodiment of the present invention, as shown in FIG. 1. However, the controlling node can be also a User Equipment (UE), such as an Open IPTV Terminal Function (OITF) 30, according to a second embodiment of the present invention.

It should be noted that the CDNC is defined in the Open IPTV forum as a functional entity which performs a cluster selection in the Content Delivery Network (CDN) based on a request issued by the IPTV Control functional entity. Many instances of a CDNC may coexist in the same CDN. They may interact for the purpose of selecting the right cluster. The Cluster Controller (CC) is a functional entity which manages a set of Content Delivery Functions (i.e. a cluster of CDFs). It terminates IPTV service session setup, it handles content delivery session setup, it proxies all message exchanges between CDFs and the ITF, and it maintains the state of the media servers (Content Delivery Functions), for example. The Content Delivery Function (CDF) is the functional entity which is responsible for media processing, delivery and distribution, under the control of the CC.

Also, it should be noted that the CDNC/CC 20 may also include the SCTE ADM functionality. The reason for this is that both the IPTV CS 12 and the CDNC/CC 20 can detect different IPTV events for opportunities of advertisement placement. For example, the IPTV CS 12 can detect events at the IPTV session control level, such as an end-user starting a new content on demand session, while the CDNC/CC 20 can detect events at the media level such as pre-roll, past-roll, pause or resume commands performed by the end-user during the viewing of the content on demand session.

The CDNC/CC 20 is connected to a Content Delivery Function (CDF) 22, which provides the actual content, such as video, for the content on demand session and the content of the targeted advertisements. Of course, there may be more than one CDF 22 connected to the CDNC/CC 20.

Once the ADS 18 has been notified of advertisement placement opportunities by the ADM 16 and has selected advertisements that are suitable for the advertisement placement opportunities, the selected advertisements are sent back to the ADM 16. Then, the insertion of the selected advertisements can be done either through a network approach or a user equipment approach. In the network approach, the CDNC/CC 20 sets up Real Time Streaming Protocol (RTSP) sessions with one of more CDFs 22, for delivery and insertion of the selected advertisements in a content stream in IPTV according to the policies transmitted by the ADM 16. In the User equipment approach, a user terminal, such as the OITF 30, sets up RTSP sessions with one or more CDFs 22 for delivery and insertion of the selected advertisements in the content stream in IPTV according to the policies transmitted by the ADM 16.

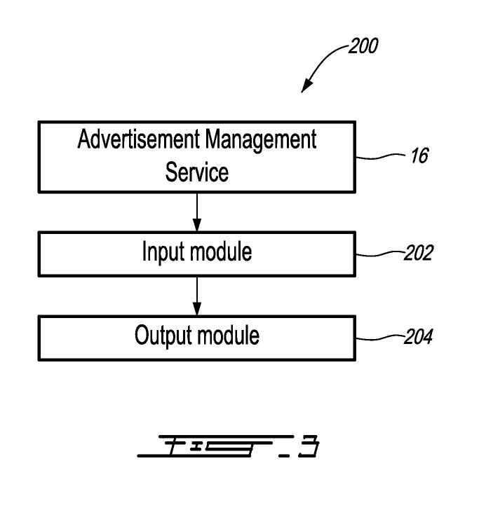

Now, turning to FIG. 2, a method 100 for inserting advertisements in a content stream in IPTV will be described. The content stream can be a multimedia stream or video stream or any other stream having useful content for an end-user.

Method 100 starts with step 102, where an external decision point, such as the ADS 18, is notified by the ADM 16 of advertisement insertion opportunities in the content stream. Before notifying the ADS 18, the ADM 16 first detects one or more advertisement placement opportunities in the content stream that the end-user is watching. More specifically, in order to notify the external decision point, the ADM 16 sends, for example, an advertisement placement opportunity request to the decision point; the advertisement placement opportunity request can comprise a content ID, a user ID, and other information that allows the ADS 18 to select appropriate advertisements for the detected placement opportunities.

Next, in step 104, in response to the notification, the ADM 16 receives the advertisements, selected by the external decision point, to be inserted in the advertisement insertion opportunities. Indeed, after the external decision point receives the advertisement placement opportunity request, it selects appropriate advertisements to be inserted, according to the information contained in the received request and then sends the selected advertisements to the ADM 16.

In step 106, upon receipt of the selected advertisements, the ADM 16 transmits policies relative to the selected advertisements for insertion in the content stream to the controlling node. More specifically, the ADM 16 defines the policies based on the received advertisements and other information.

Once the controlling node receives the policies, it takes care of inserting the selected advertisements based on the policies received from the ADM 16.

The policies relative to the advertisements to be inserted comprise, for example, an advertisement ID to identify the selected advertisements to be inserted, a link where to fetch the selected advertisements using, for example, Uniform Resource Locators (URLs), duration for the selected advertisements, etc.

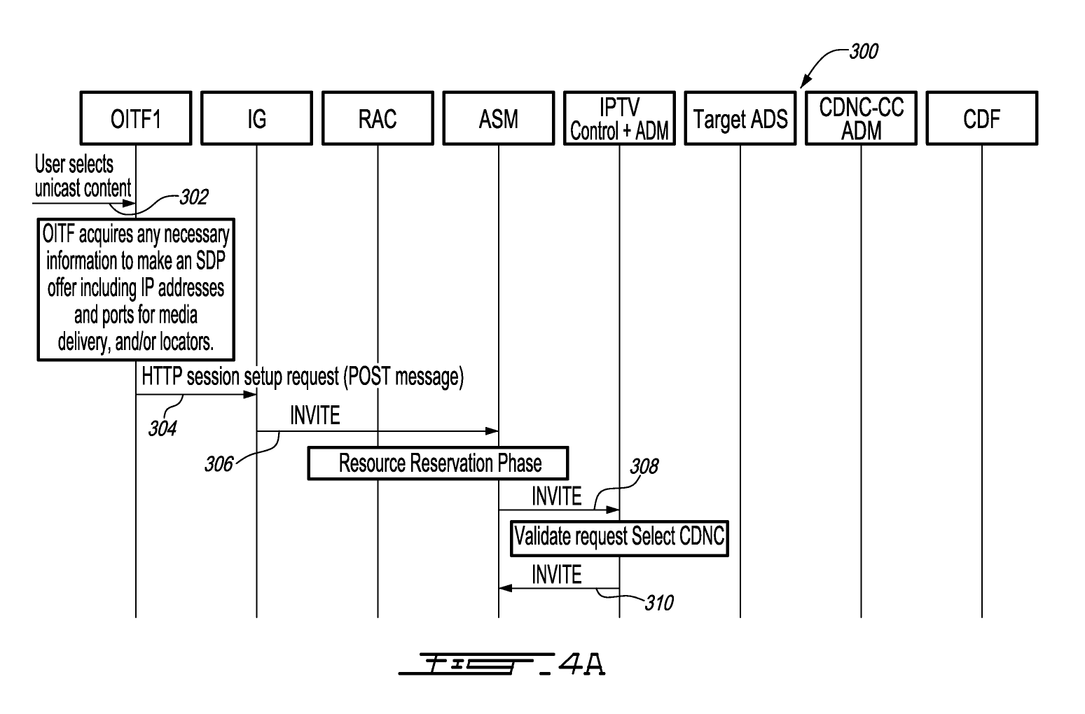

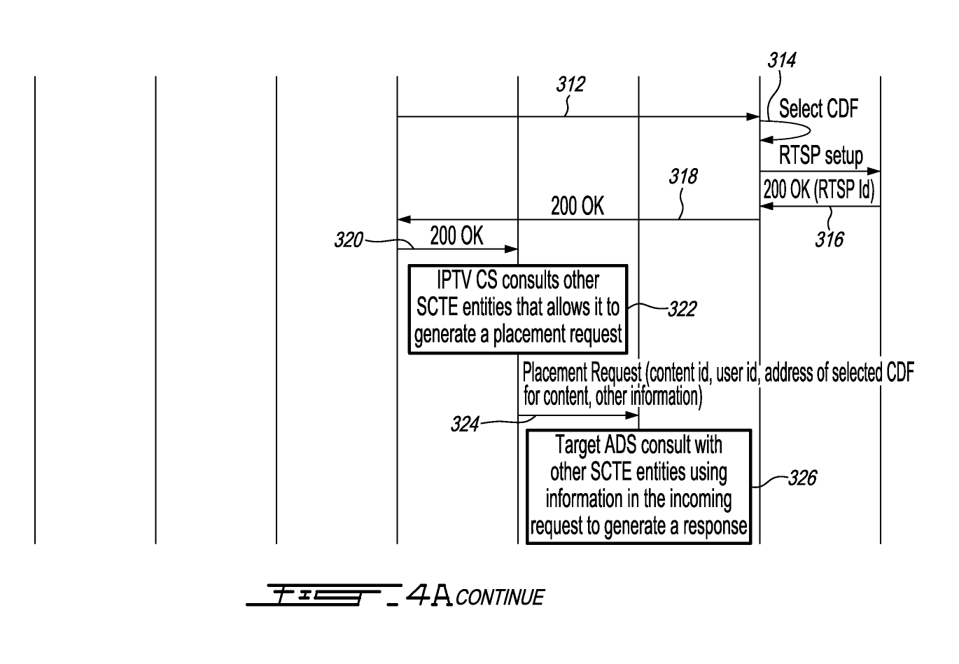

FIG. 3 illustrates a system 200 for inserting advertisements in a content stream in IPTV in which method 100 of FIG. 2 can be performed. The system 200 can be for example the IPTV CS 12.

More specifically, the system 200 comprises an advertisement management service, such as the ADM 16, for notifying an external decision point of advertisement placement/insertion opportunities in a content stream. The system 200 also comprises an input module 202 and an output module 204.

Before notifying the external decision point, the ADM 16 first detects advertisement placement/insertion opportunities in the content stream that an end-user is watching. For example, the ADM 16 can detect that the end-user has started a new content on demand session or that he/she has triggered the pause command, for example.

The input module 202 allows for receiving advertisements selected by the external decision point, to be inserted in the detected advertisement placement opportunities, in response to the notification. Indeed, once the external decision point receives the notification, it selects advertisements, which are suitable to be inserted in the advertisement placement opportunities and return them to the ADM 16. Furthermore, in cases where there are updates or changes in the selected advertisements to be inserted, the input module 202 also receives those updates from the external decision point, for example. Also, the output module 204 allows for reporting activity events back to the ADS 18, such as to report the events related to advertisement placements, placement execution etc., and other fulfillment data that are of interest to the ADS 18 (e.g. viewer related events).

Once the input module 202 receives the selected advertisements from the external decision point, the ADM 16 defines some policies based on the received advertisements and other information. The output module 204 of the system 200 then allows for transmitting those policies relative to the selected advertisements to be inserted to a controlling node, which can be a CDNC/CC 20 or a UE 30. The controlling node takes care of inserting the selected advertisements according to the received policies, i.e. when and where to insert the selected advertisements and for how long, etc. Also, when the input module 202 receives updates relative to the selected advertisements to be inserted from the external decision point, the ADM 16 updates the policies and the output module 204 forwards to the controlling node the updated policies relative to the updates of the selected advertisements.

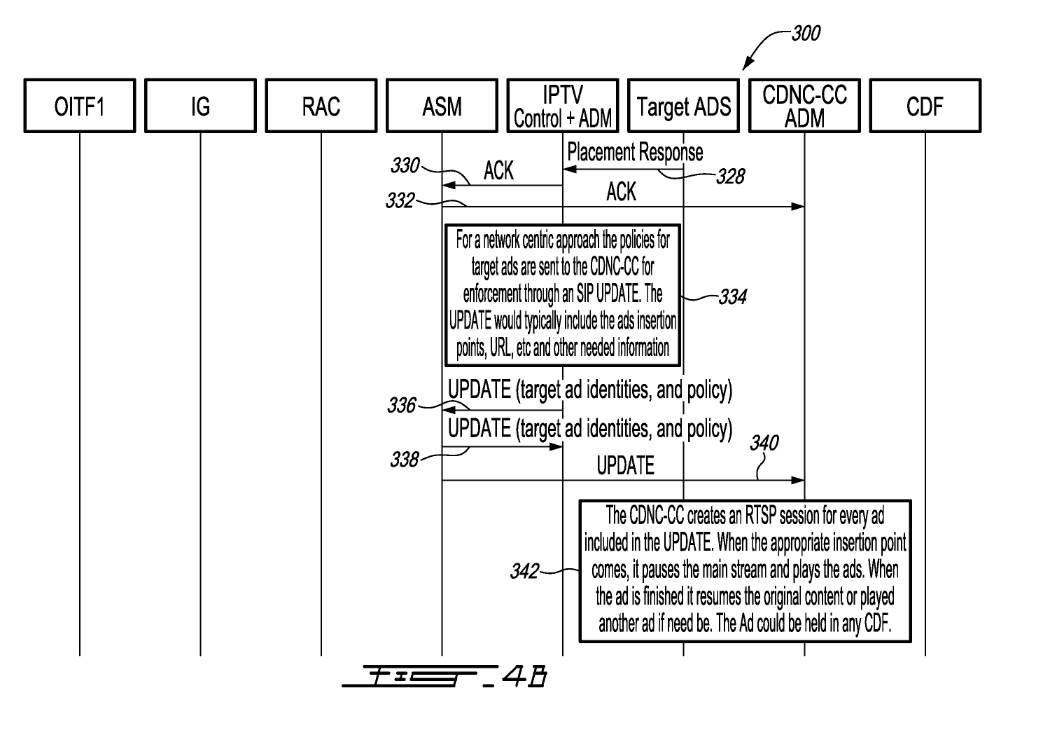

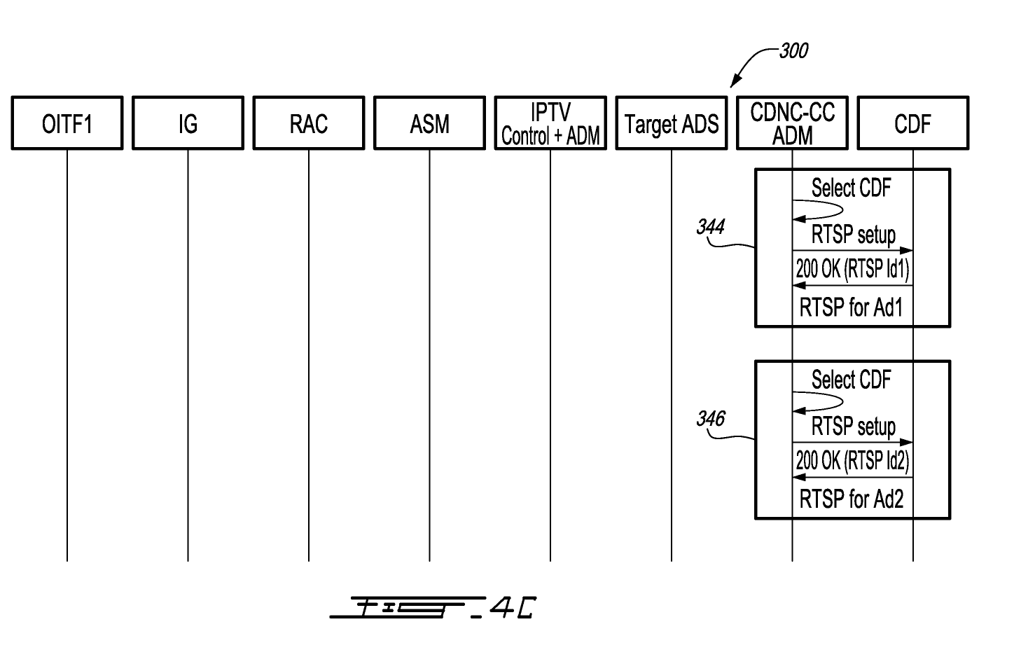

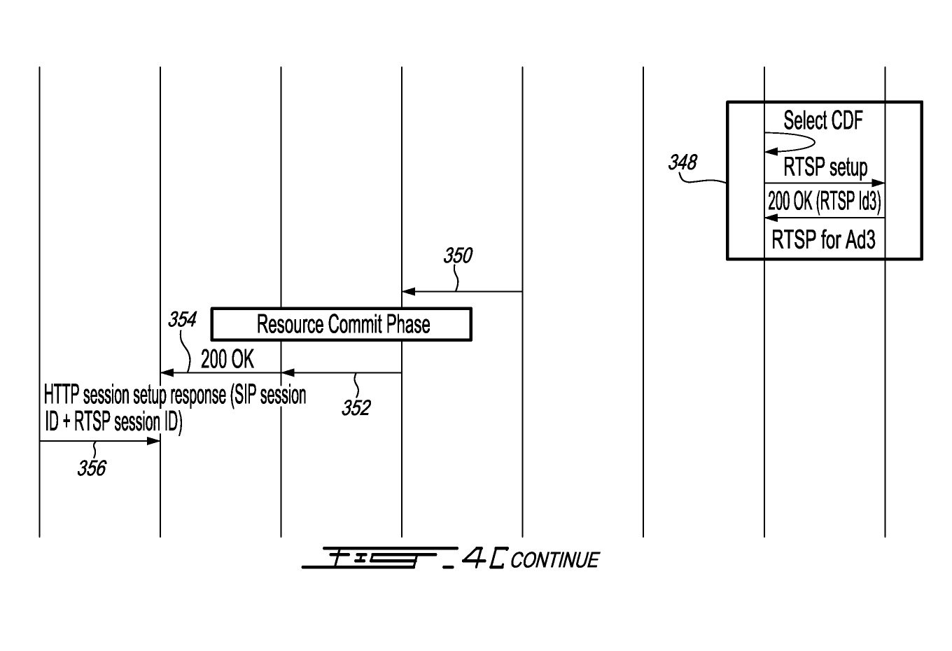

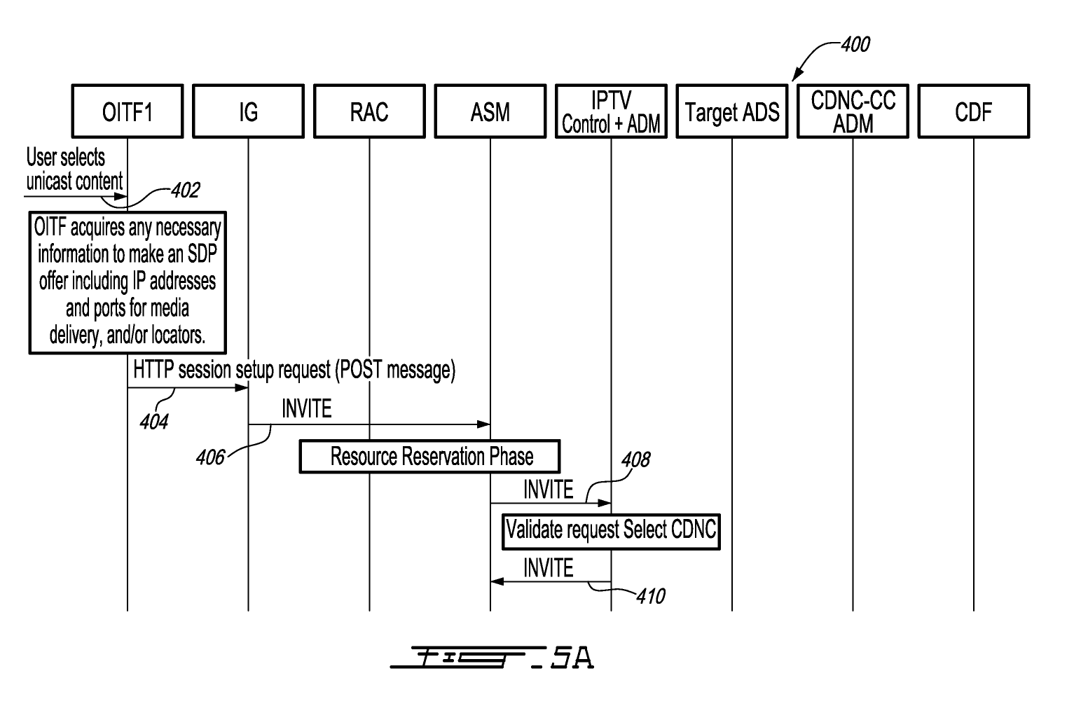

Now, turning to FIGS. 4A, 4B and 4C, method 100 will be described in more detail in the call flow 300, when performed in the context of the interworking architecture of FIG. 1. It should be noted that FIGS. 4A to 4C illustrate a network approach for inserting the selected advertisements after the ADM 16 and the ADS 18 have respectively detected the advertisement placement opportunities and selected suitable advertisements to be inserted.

It is assumed that all pre-requisites operations required by the SCTE 130 standard to be performed between the ADM 16 and ADS 18 have taken place but are not shown in the call flow 300 of FIGS. 4A to 4C, since they are not relevant to the embodiments of the present invention. Also, in this exemplary call flow 300, several messages transit through an Authentication and Session Management (ASM) for compliance with the current IPTV and IMS standards. Nevertheless, the ASM does not take part in the embodiments of the present invention. Thus, the ASM will not be further described. In the same way, an IMS Gateway (IG) and a Resource Admission Control (RAC) are present for compliance with the IPTV and IMS standards but do not take part in the embodiments of the present invention. However, more details about these different elements (ASM, IG, RAC, etc.) and their interactions can be found in the reference called Open IPTV Forum: Functional Architecture v 1.2, 2008-12-08, which is publicly available at the following link: http://www.openiptvforum.org/docs/OIPF-Functional_Architecture-V1.2bis-APPROVED.pdf.

Steps 302 to 320 are believed to be well-known in the art for establishing a content on demand session, such as a video on demand session and thus they will not be described further.

In step 322, the IPTV CS 12 realizes that the present content on demand session is subject to target advertisements, through for example, subscription, or type of the control (e.g. TV program). Thus, the ADM 16 starts detecting advertisement placement opportunities for this session. To do so, the ADM 16 can consult with other SCTE entities such as the CIS, the SIS, the POIS, or with other entities for help. It should be noted that these elements are not related to the embodiments of the present invention but can help in generally understanding further the interactions between the ADM 16 and the ADS 18. The search or detection of the advertisement placement opportunities can be based on the content requested by the end-user during the content on demand session, on the end-user identity, and on other factors.

After the detection of the advertisement placement opportunities, the ADM 16 sends an advertisement placement request to the ADS 18 so as to notify the ADS 18 of the advertisement placement opportunities, in step 324. It should be noted that the ADS 18 makes the decision on the selection and delivery of any advertisement. The advertisement placement request can comprise a content ID, a user ID, the address of the CDF 22 selected for the current content to be streamed to the end-user and other information that allows the ADS 18 to choose the targeted advertisements for the session, for example.

In step 326, upon receipt of the advertisement placement request, the ADS 18 in turn consults with some SCTE entities and decides on the advertisements that will be inserted.

In step 328 of FIG. 4B, the ADS 18 returns its response to the ADM 16 of the IPTV CS 12. The response comprises the selected advertisements to be inserted, for example.

In steps 330 and 332, the IPTV CS 12 completes one end of the IMS session by sending an acknowledgement to the ASM and from the ASM to the CDNC/CC 20.

In step 334, the ADM 16 creates or defines policies relative to the advertisements selected by the ADS 18. The ADM 16 sends these policies to the controlling node, which is the CDNC/CC 20 in the case of a network approach.

More specifically, the IPTV CS 12 uses SIP UPDATE to report the defined policies, which can comprise IDs of the advertisements to be inserted, advertisement URLs, duration for the advertisements, insertion points, other information, etc., to the CDNC/CC 20 so that the CDNC/CC 20 can enforce the received policies. It should be noted that the information about the policies relative to the advertisements to be inserted is not sent in the acknowledgement message of the previous steps because this would break down the offer-answer model of SIP. Consequently, the information about the policies is sent separately in a SIP UPDATE message.

Step 334 further comprises steps 336 to 340, where the UPDATE message is sent to the ASM and back to the CDNC/CC 20.

The CDNC/CC 20 then initiates a separate RTSP session for each of the selected advertisements in step 342. When the actual time or point of insertion for the advertisement insertion arrives, as defined by the policies, the CDNC/CC 20 pauses the content stream of the content on demand session, starts playing the selected advertisement, and when the selected advertisement is over, resumes the streaming of the actual content. It should be noted that more than one advertisements can be streamed before the actual content resumes streaming (see steps 344 to 348). The CDFs 22 in which the advertisements are stored can be in the same or in one or more distinct servers as the server that supplies the content of the content on demand session.

Finally the IMS session on the originating side, initiated by the end-user through steps 300-320, is completed in steps 350 to 356 so as to allow the end-user to start streaming the content, such as video, of the content on demand session.

It should be noted that in the call flow of FIGS. 4A to 4C, SIP UPDATE is used. Alternatively, SIP INFO, using info-event packages, may be used to convey policies about the selected advertisements to be inserted to the controlling node or the CDNC/CC 20. According to this option, XML data can be included as defined by SCTE without any changes in info-event packages, which can be defined to match the SCTE 130-3 XML data. In this case, steps 336 to 340 of method 300 are changed to SIP INFO instead of SIP INFO.

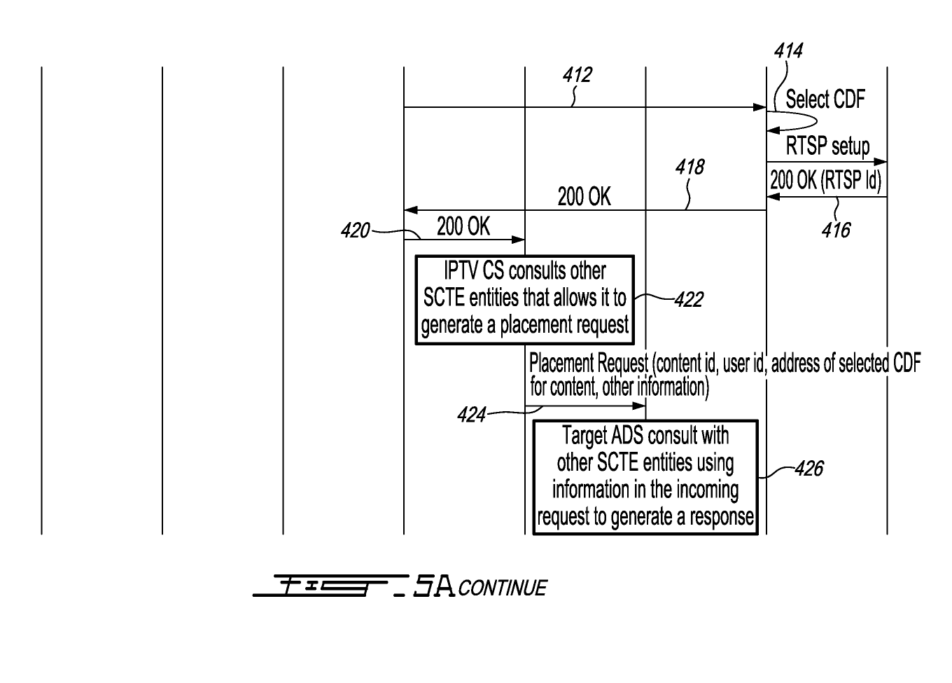

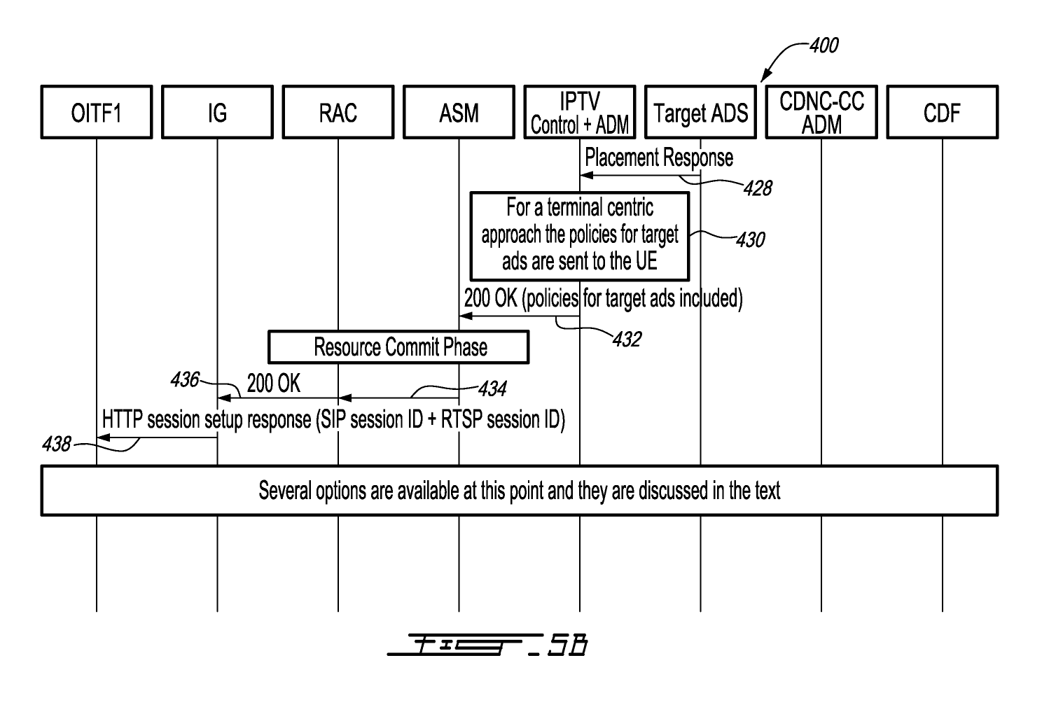

FIGS. 5A and 5B illustrate a call flow 400 of method 100 in more detail when applied to a user terminal approach.

The call flow 400 starts with steps 402 to 428, which are similar to steps 302 to 328 of the call flow 300 of FIG. 4A for establishing a content on demand session, for notifying advertisement placement opportunities and sending an advertisement placement request to the ADS 18 and receiving a response from the ADS 18, the response including the selected advertisements to be inserted.

In steps 430 to 438, the IPTV CS 12 transmits the policies defined by the ADM 16 relative to the selected advertisements to the UE, such as the OITF 30 as illustrated in FIG. 1. The policies can be sent to the UE in the 200 OK message during the content on demand session initiation phase, for example.

Once the UE or OITF 30 receives the policies, the UE or OITF 30 has several options to fetch the selected advertisements and insert them according to the received policies.

For example, the UE can retrieve all the selected advertisements using “HTTP” and store them locally, in the UE. When the time for an advertisement arrives, the UE pauses the content stream and renders the corresponding advertisement according to the received policies.

The UE can also establish multiple RTSP sessions, one for each advertisement. For each advertisement, when the time for the advertisement arrives, the UE pauses the content stream and then plays the advertisement.

As mentioned before, additional interactions between the ADM 16 and ADS 18 also include updates from each other. For example, the ADS 18 can update the ADM 16 regarding changes in advertisement availability by sending a Placement Status Notification, to which the ADM 16 replies with a Placement Status Acknowledgement. Then, the update information is sent to the CDNC/CC 20 in a SIP UPDATE message for the network approach of inserting the advertisements. In a user approach, the update information is sent to the UE 30 in a SIP UPDATE message for enforcement of the information. It should be noted that SIP INFO can also be used instead of SIP UPDATE.

In the interworking architecture 10 of FIG. 1, event collection and reporting can be also possible. More specifically, it is possible to collect end-user media play out related events that would take place from the moment the end-user starts a content on demand session that includes targeted advertisement insertion until the end of the content on demand session. For example, the end-user media play out events may comprise events such as “pause”, “resume”, “Fast Forwarding (FF)”, etc. By reporting and collecting these events, it helps service providers to gather useful information regarding the success of the targeted advertisements, i.e. whether the advertisements have been seen, skipped, etc. This can constitute a feedback mechanism to assess the actual effectiveness of the targeted advertisements.

Furthermore, through the stamps associated with the events and the advertisement times, it is possible to see the end-users' habits towards certain advertisements in addition to the effects of the advertisements on the end-users.

There are, for example, two options for reporting and collecting the events.

The first option uses the CDNC/CC 20 for reporting the events. To do so, the CDNC/CC 20 sends a Placement Status Notification message to the ADS 18, the message containing the information about the events. Since the CDNC/CC 20 is in the signaling control plane for setting up a session and is in the path of RTSP media control requests, it has access to events, such as pause, play, FF, etc., and can report them using SCTE messages, such as the Placement Status Notification. The ADS 18 replies back to the CDNC/CC 20 by sending an acknowledgment message.

The second option uses the IPTV CS 12 to report the events, through an event collector, for example. To do so, it sends a Placement Status Notification message to the ADS 18. The IPTV CS 12 is in the signaling control plane for setting up a session. It does not have access to the RSTP media control requests, thus it cannot obtain events such as pause, resume, play, FF, etc. However, the IPTV CS 12 can acquire information about those events from the CDNC/CC 20 through a SIP SUBSCRIBE/NOTIFY mechanism or through other mechanisms. The ADS 18 replies back to the IPTV CS 12 by sending an acknowledgment message.

One advantage of the second option is that the IPTV CS 12 is a centralized node, thus it can aggregate information from several other nodes relating to a number of different sessions before reporting the events to the ADS 18.

Modifications and other embodiments of the disclosed invention will come to mind to one skilled in the art having the benefit of the teachings presented in the foregoing description and the associated drawings. Therefore, it is to be understood that the invention is not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1. A method for inserting advertisements in a content stream in IPTV, the method comprising:
notifying an external decision point of advertisement insertion opportunities in the content stream;
receiving, in response to the notification, advertisements selected by the external decision point, to be inserted in the advertisement insertion opportunities; and
transmitting to a controlling node policies relative to the selected advertisements for insertion in the content stream.

2. The method of claim 1, wherein notifying the external decision point of the advertisement insertion opportunities comprises first detecting opportunities of insertion of the advertisements at an IPTV session control level by detecting an end-user starting a content on demand session.

3. The method of claim 1, wherein notifying the external decision point of the advertisement insertion opportunities comprises first detecting opportunities of insertion of the advertisements at a content level by detecting one of pre-roll, past-roll, pause and resume commands during a content on demand session.

4. The method of claim 1, wherein notifying the external decision point of the advertisement insertion opportunities comprises sending to the external decision point an advertisement placement request including at least a content ID, a user ID and other information that allows the external decision point to select advertisements suitable for the advertisement insertion opportunities.

5. The method of claim 1, wherein the policies relative to the selected advertisements for insertion in the content stream comprise at least IDs of the selected advertisements, links of the selected advertisements, and duration of the selected advertisements for insertion.

6. The method of claim 1, wherein transmitting the policies relative to the selected advertisements comprises using SIP UPDATE.

7. The method of claim 1, wherein transmitting the policies relative to the selected advertisements comprises using SIP INFO.

8. The method of claim 1, prior to transmitting the policies relative to the selected advertisements comprising defining the policies based on the received advertisements.

9. The method of claim 1, wherein transmitting the policies to the controlling node comprises transmitting the policies to a content delivery network controller, which sets up real time streaming protocol sessions with at least one content delivery functions for advertisement delivery.

10. The method of claim 1, wherein transmitting the policies to the controlling node comprises transmitting the policies to a user terminal, which sets up real time streaming protocol sessions with at least one content delivery functions for advertisement delivery.

11. The method of claim 1, further comprising receiving updates related to the selected advertisements for insertion from the external decision point.

12. The method of claim 11, wherein receiving the updates comprises receiving changes in advertisement availability from the external decision point.

13. The method of claim 12, further comprising forwarding the changes to the controlling node.

14. A system for inserting advertisements in a content stream in PTV, the system comprising:
an advertisement management service for notifying an external decision point of advertisements insertion opportunities in the content stream;
an input module, in response to the notification, for receiving advertisements selected by the external decision point, to be inserted in the advertisement insertion opportunities; and
an output module for transmitting to a controlling node policies relative to the selected advertisements for insertion in the content stream.

15. The system of claim 14, wherein the advertisement management service is further for detecting opportunities of insertion of the advertisements at an IPTV session control level by detecting an end-user starting a content on demand session.

16. The system of claim 14, wherein the advertisement management service is further for detecting opportunities of insertion of the advertisements at a content level by detecting one of pre-roll, past-roll, pause and resume commands during a content on demand session.

17. The system of claim 14, wherein the advertisement management service is further for sending an advertisement placement request including at least a content ID, a user ID, and other information that allows the external decision point to select advertisements suitable for the advertisement insertion opportunities.

18. The system of claim 14, wherein the policies relative to the selected advertisements for insertion in the content stream comprise at least IDs of the selected advertisements, links of the selected advertisements and duration of the selected advertisements for insertion.

19. The system of claim 14, wherein the output module transmits the policies to a content delivery network controller, which sets up real time streaming protocol sessions with at least one content delivery functions for advertisement delivery.

20. The system of claim 14, wherein the output module transmits the policies to a user terminal, which sets up real time streaming protocol sessions with at least one content delivery functions for advertisement delivery.

21. The system of claim 14, wherein the input module further receives updates related to the selected advertisements for insertion from the external decision point.

22. The system of claim 21, wherein the updates comprise changes in advertisement availability.

23. The system of claim 22, wherein the output module forwards the changes to the controlling node.

24. The system of claim 14, further comprising an event collector for collecting and reporting statistics and effectiveness about the selected advertisements.
